(19) United States
(12) Patent Application Publication
(10) Pub. No.: US 2024/0255716 A1
(43) Pub. Date: Aug. 1, 2024

(54) ARMORED, INSULATED, FIBER OPTIC CABLES

(71) Applicant: AFL Telecommunications LLC, Duncan, SC (US)

(72) Inventors: Brett Villiger, Simpsonville, SC (US); Stephen Martin, Wellford, SC (US); Robert Dillon, Travelers Rest, SC (US); Joseph Cignarale, Greer, SC (US); Robert Ragless, Shrivenham (GB)

(21) Appl. No.: 18/220,539

(22) Filed: Jul. 11, 2023

Related U.S. Application Data
(60) Provisional application No. 63/441,626, filed on Jan. 27, 2023.

(51) Int. Cl. G02B 6/44

(52) U.S. Cl. CPC G02B 6/4432; G02B 6/4413; G02B 6/44384; G02B 6/4488

(57) ABSTRACT

Fiber optic cables are provided. A fiber optic cable includes a central core formed from a first thermoplastic material, wherein a central interior is defined within the central core. The fiber optic cable further includes a protective jacket surrounding and in contact with the central core, the protective jacket formed from a second thermoplastic material. The fiber optic cable further includes an armor layer surrounding and in contact with the protective jacket, the armor layer including a plurality of metal rods disposed in an annular array. The fiber optic cable further includes a plurality of optical fibers disposed within the central core.

### CROSS-REFERENCE TO RELATED APPLICATIONS

The present application claims priority to U.S. Provisional Patent Application Ser. No. 63/441,626 filed on Jan. 27, 2023, the disclosure of which is incorporated by reference herein in its entirety.

### FIELD

The present disclosure relates generally to fiber optic cables, and more particularly to improved fiber optic cables which are sufficiently armored and insulated for rugged environments while also facilitating the use of a high number of optical fibers within a small cable size.

### BACKGROUND

Fiber optic cables are utilized in a variety of different environments for a variety of different purposes, including the conveyance of data via the passage of light through optical fibers of the fiber optic cables. As data requirements increase, the demand for increased numbers of optical fibers in each cable correspondingly increases. However, customers also require such cables to have small diameters and light weights.

Further, in many cases, fiber optic cables are exposed to rugged environments where they are particularly susceptible to damage. For example, in some cases, fiber optic cables are utilized in railway applications in which the cables may be placed within the right of way of rail transit or on top of rail ballast. These cables can be exposed to damage from railway vehicles, workers, tools, etc.

Accordingly, improved fiber optic cables which are suitable for use in such rugged environments are desired in the art. In particular, fiber optic cables which are suitable insulated and armored for rugged environments which also accommodating large numbers of optical fibers within small diameters would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a fiber optic cable is provided. The fiber optic cable includes a central core formed from a first thermoplastic material, wherein a central interior is defined within the central core. The fiber optic cable further includes a protective jacket surrounding and in contact with the central core, the protective jacket formed from a second thermoplastic material. The fiber optic cable further includes an armor layer surrounding and in contact with the protective jacket, the armor layer including a plurality of metal rods disposed in an annular array. The fiber optic cable further includes a plurality of optical fibers disposed within the central core.

In accordance with another embodiment, a fiber optic cable is provided. The fiber optic cable includes a central core formed from a first thermoplastic material, wherein a central interior is defined within the central core. The fiber optic cable further includes a protective jacket surrounding and in contact with the central core, the protective jacket formed from a second thermoplastic material. The fiber optic cable further includes an armor layer surrounding and in contact with the protective jacket, the armor layer including a plurality of metal rods disposed in an annular array. The fiber optic cable further includes an outer jacket surrounding and in contact with the armor layer, the outer jacket formed from a third thermoplastic material. The fiber optic cable further includes a plurality of optical fibers disposed within the central core. A maximum outer diameter of the cable is less than or equal to 26.5 millimeters and the plurality of optical fibers is greater than or equal to 144 optical fibers.

In accordance with another embodiment, a fiber optic cable is provided. The fiber optic cable includes a central core formed from a high density polyethylene, wherein a central interior is defined within the central core. The fiber optic cable further includes a protective jacket surrounding and in contact with the central core, the protective jacket formed from a polyurethane. The fiber optic cable further includes an armor layer surrounding and in contact with the protective jacket, the armor layer comprising a plurality of steel rods disposed in an annular array. The fiber optic cable further includes an outer jacket surrounding and in contact with the armor layer, the outer jacket formed from a high density polyethylene. The fiber optic cable further includes a plurality of optical fibers disposed within the central core. A maximum outer diameter of the cable is less than or equal to 26.5 millimeters and the plurality of optical fibers is greater than or equal to 144 optical fibers.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a cross-sectional view of a fiber optic cable in accordance with embodiments of the present disclosure;

FIG. 2 is a perspective sectional view of the fiber optic cable of FIG. 1;

FIG. 3 is a cross-sectional view of a fiber optic cable in accordance with other embodiments of the present disclosure;

FIG. 4 is a perspective sectional view of the fiber optic cable of FIG. 3;

FIG. 5 is a schematic top view of a plurality of optical fibers utilized in a fiber optic cable in accordance with some embodiments of the present disclosure; and

FIG. 6 is a schematic top view of a plurality of optical fibers utilized in a fiber optic cable in accordance with other embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to improved fiber optic cables for use in rugged environments such as railway applications. For example, such fiber optic cables are suitable armored and insulated for such environments, which also being capable of accommodating a large number of optical fibers, such as greater than or equal to 144, 288, 432, or 864 optical fibers, in a small maximum cable outer diameter, such as less than or equal to 26.5 millimeters, 26.4 millimeters, 26.3 millimeters, 22.5 millimeters, 22.4 millimeters, or 22.3 millimeters. Such cables may further advantageously have maximum weights of less than or equal to 1300 kilograms per kilometer, such as less than or equal to 1299 kilograms per kilometer, less than or equal to 1298 kilograms per kilometer, such as less than or equal to 1297 kilograms per kilometer. Such cables may further advantageously comply with the requirements of ISO 9001 effective as of the date of filing of the present application, and may further specifically comply with the requirements of ISO 9001: 2015 effective as of the date of filing of the present application.

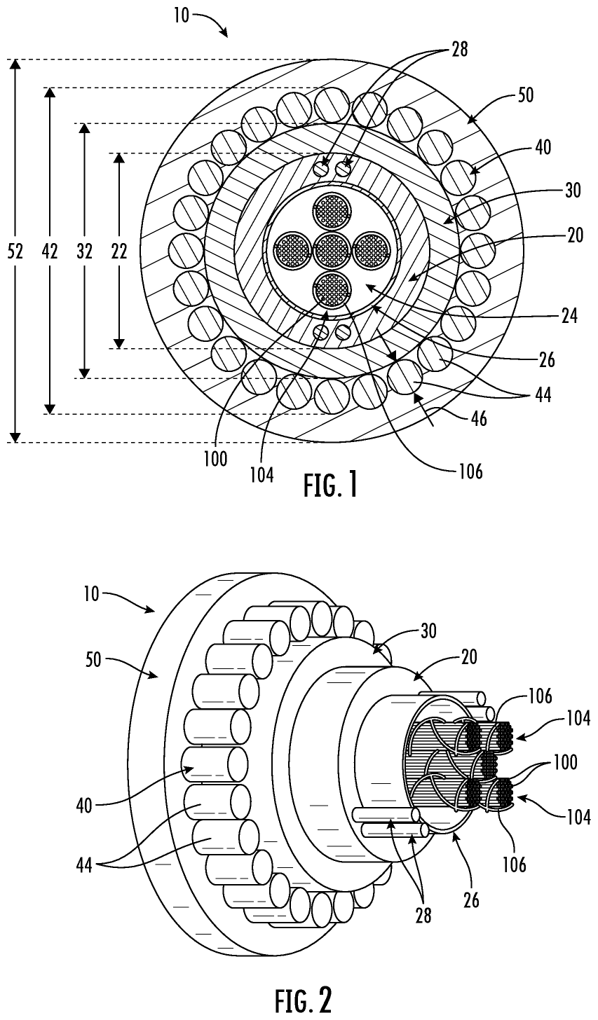

Referring now to the drawings, FIGS. 1 through 4 illustrate embodiments of fiber optic cables 10 in accordance with embodiments of the present disclosure. A fiber optic cable 10 may include, for example, a central core 20. The central core 20 may have a maximum outer diameter 22 and may further define a central interior 24. Further, the central core 20 may be formed from a first thermoplastic material.

Maximum outer diameter 22 may, in exemplary embodiments, be less than or equal to 14 millimeters, such as less than or equal to 13.7 millimeters, such as less than or equal to 13.5 millimeters.

The first thermoplastic material may, for example, be a polyethylene, such as in exemplary embodiments a high density polyethylene.

Central core 20 may be the core layer which houses a plurality of optical fibers 100 in a central tube configuration. The plurality of optical fibers 100 are thus disposed within the central core 20, such as in the central interior 24 thereof.

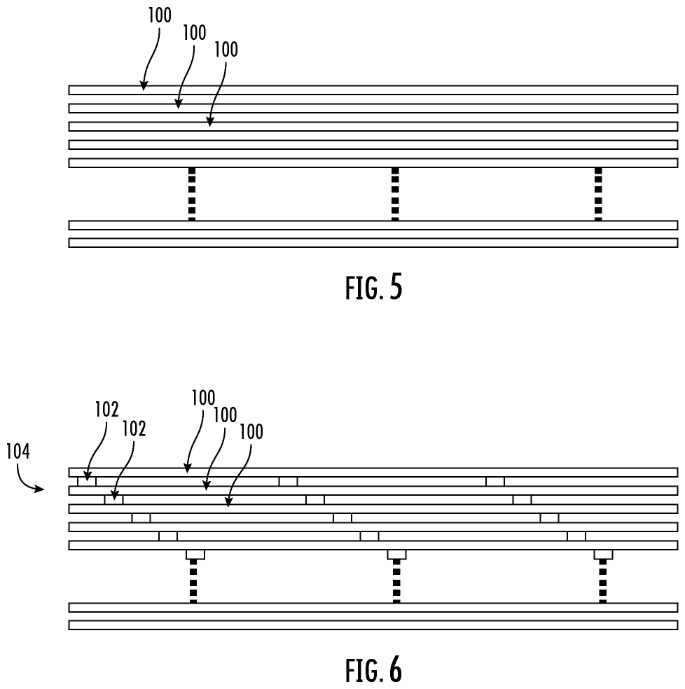

Any suitable optical fibers 100 may be utilized in cable 10. For example, the optical fibers 100 may be single mode optical fibers or multi-mode optical fibers. Further, in some embodiments, the optical fibers 100 may have nominal (plus or minus 3 microns) outer diameters of 250 microns. In alternative embodiments, the optical fibers 100 may have nominal outer diameters of 200 microns. In some embodiments, as illustrated in FIG. 5, the optical fibers 100 may be loose optical fibers which are not ribbonized or otherwise bonded to each other. In alternative embodiments, the optical fibers 100 may be ribbonized to form one or more optical fiber ribbons. For example, in some embodiments as illustrated in FIG. 6, the optical fibers 100 may be intermittently bonded to each other (via, for example, portions of the outermost jacket or layer of the optical fibers 100), thus forming one or more intermittently bonded optical fiber ribbons 104. Such intermittent bonding may occur along the lengths of the optical fibers 100, thus leaving non-bonded gaps between neighboring optical fibers 100 as shown. Further, the bonded portions 102 of neighboring optical fibers 100 may be staggered along the lengths of the optical fibers 100 such that neighboring optical fibers 100 in a ribbon 104 are bonded to each other at different locations along their lengths and the length of the ribbon 104.

Referring again to FIGS. 1 through 4, in some embodiments, one or more ribbons 104 may be bundled, such as via use of one or more bunding members 106 wound around the ribbon(s) 104. Bundling members 106 may be suitable strings, cords, wires, etc.

In exemplary embodiments, a relatively large number of optical fibers are disposed within the central core 20 and central interior 24 thereof. For example, the number of optical fibers 100 within the central core 20 and central interior 24 thereof may be greater than or equal to 144 optical fibers 100, such as greater than or equal to 288 optical fibers 100, such as greater than or equal to 432 optical fibers 100, such as greater than or equal to 864 optical fibers 100. In some exemplary embodiments, the optical fibers 100 are arranged as intermittently bonded optical fiber ribbons 104. Further, in some embodiments, each optical fiber ribbon 104 includes 8 or more, such as 10 or more, such as 12 or more, optical fibers 100. Further, in some embodiments, each optical fiber ribbon 104 is bundled.

In some embodiments, a water blocking tape 26 is included in the cable 10. For example, water blocking tape 26 may be disposed within the central core 20 and central interior 24 thereof, such as between the plurality of optical fibers 100 and the central core 20.

In some embodiments, the central core 20 may be a dry core having a dry central interior 24, with no gels or other “wet” materials included in the central interior 24.

In some embodiments, one or more, such as a plurality of, strength rods 28 may be embedded in the central core 20. Strength rods 28 may, for example, be formed from fiber-reinforced polymer materials or metals. In some embodiments, as illustrated, one or more pairs of strength rods 28 may be embedded in the central core 20, and may for example, be disposed in opposite sides of the central core 20 relative to a longitudinal axis of the central core 20.

Cables 10 in accordance with the present disclosure may further include a protective jacket 30 surrounding and in contact (e.g. direct contact) with the central core 20. The protective jacket 30 may serve as an additional protective and insulative layer for the optical fibers 100. The protective jacket 30 may have a maximum outer diameter 32. Further, the protective jacket 30 may be formed from a second thermoplastic material.

Maximum outer diameter 32 may, in exemplary embodiments, be less than or equal to 18 millimeters, such as less than or equal to 17.7 millimeters, such as less than or equal to 17.5 millimeters.

The second thermoplastic material may be the same or different from the first thermoplastic material. In some embodiments, for example, the second thermoplastic material may be different from the first thermoplastic material and may, for example, be a polyurethane.

Cables 10 in accordance with the present disclosure may further include an armor layer 40 surrounding and in contact (e.g. direct contact) with the protective jacket 30. The armor layer 40 may serve as the primary protective layer for the optical fibers 100. The armor layer 40 may have a maximum outer diameter 42. Further, the armor layer 40 may be formed from and include a plurality of metal rods 44 disposed in an annular array.

Maximum outer diameter 42 may, in exemplary embodiments, be less than or equal to 22.5 millimeters, such as less than or equal to 22.4 millimeters, such as less than or equal to 22.3 millimeters.

Metal rods 44 may be formed from any suitable metal, such as in exemplary embodiments steel. Each metal rod 44 may have a maximum outer diameter 46 of less than or equal to 2.6 millimeters, such as less than or equal to 2.5 millimeters, such as less than or equal to 2.4 millimeters. The armor layer 40 may include, for example, greater than or equal to 18 metal rods 44, such as greater than or equal to 20 metal rods 44, such as greater than or equal to 22 metal rods 44, such as greater than or equal to 24 metal rods 44.

In exemplary embodiments as shown, the metal rods 44 are helically stranded in the cable 10, and thus extend helically about the longitudinal axis of the cable 10. Alternatively, the metal rods 44 may be straight-laid in the cable 10, and thus each extend generally parallel to a longitudinal axis of the cable 10.

As shown, the metal rods 44 of the armor layer 40 are generally not embedded in any additional materials, and thus the rods 44 themselves are in contact (e.g. direct contact) with the protective jacket 30.

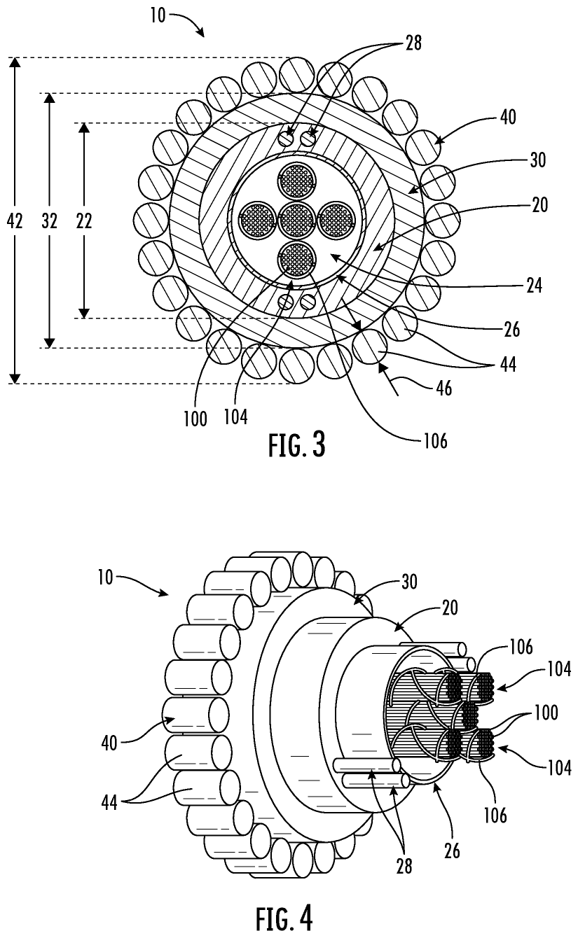

In some embodiments, as illustrated in FIGS. 3 and 4, the armor layer 40 is the outermost layer of the cable 10. According, the maximum outer diameter of the cable 10 in these embodiments may be less than or equal to 26.5 millimeters, such as less than or equal to 22.5 millimeters, such as less than or equal to 22.4 millimeters, such as less than or equal to 22.3 millimeters.

Alternatively, in exemplary embodiments as illustrated in FIGS. 1 and 2, cables 10 in accordance with the present disclosure may further include an outer jacket 50 surrounding and in contact (e.g. direct contact) with the armor layer 40, such as the metal rods 44 thereof. The outer jacket 50 may serve as an outermost insulative layer for the optical fibers 100. The outer jacket 50 may have a maximum outer diameter 52. Further, the outer jacket 50 may be formed from a third thermoplastic material.

Maximum outer diameter 52 may, in exemplary embodiments, be less than or equal to 26.5 millimeters, such as less than or equal to 26.4 millimeters, such as less than or equal to 26.3 millimeters.

The third thermoplastic material may be the same or different from the first thermoplastic material. In some embodiments, for example, the third thermoplastic material may be the same as from the first thermoplastic material and may, for example, be a polyethylene, such as a high density polyethylene.

In these embodiments, the outer jacket 50 is the outermost layer of the cable 10. According, the maximum outer diameter of the cable 10 in these embodiments may be less than or equal to 26.5 millimeters, such as less than or equal to 26.4 millimeters, such as less than or equal to 26.3 millimeters.

Further aspects of the invention are provided by one or more of the following embodiments:

A fiber optic cable including a central core formed from a first thermoplastic material, wherein a central interior is defined within the central core; a protective jacket surrounding and in contact with the central core, the protective jacket formed from a second thermoplastic material; an armor layer surrounding and in contact with the protective jacket, the armor layer comprising a plurality of metal rods disposed in an annular array; and a plurality of optical fibers disposed within the central core.

A fiber optic cable in accordance with any one or more embodiments as shown and described herein, wherein the armor layer is the outermost layer.

A fiber optic cable in accordance with any one or more embodiments as shown and described herein, further comprising an outer jacket surrounding and in contact with the armor layer, the outer jacket formed from a third thermoplastic material.

A fiber optic cable in accordance with any one or more embodiments as shown and described herein, wherein the third thermoplastic material is a high density polyethylene.

A fiber optic cable in accordance with any one or more embodiments as shown and described herein, wherein the first thermoplastic material is a high density polyethylene.

A fiber optic cable in accordance with any one or more embodiments as shown and described herein, wherein the second thermoplastic material is a polyurethane.

A fiber optic cable in accordance with any one or more embodiments as shown and described herein, wherein the metal rods are steel rods.

A fiber optic cable in accordance with any one or more embodiments as shown and described herein, wherein the metal rods are helically stranded.

A fiber optic cable in accordance with any one or more embodiments as shown and described herein, further comprising a plurality of strength rods embedded in the central core.

A fiber optic cable in accordance with any one or more embodiments as shown and described herein, wherein a maximum outer diameter of the cable is less than or equal to 26.5 millimeters.

A fiber optic cable in accordance with any one or more embodiments as shown and described herein, wherein the plurality of optical fibers is greater than or equal to 144 optical fibers.

A fiber optic cable in accordance with any one or more embodiments as shown and described herein, wherein the plurality of optical fibers is greater than or equal to 432 optical fibers.

A fiber optic cable in accordance with any one or more embodiments as shown and described herein, wherein the plurality of optical fibers are arranged as a plurality of intermittently bonded optical fiber ribbons.

A fiber optic cable in accordance with any one or more embodiments as shown and described herein, further comprising a water blocking tape disposed between the plurality of optical fibers and the central core.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fiber optic cable, comprising:
a central core formed from a first thermoplastic material, wherein a central interior is defined within the central core;
a protective jacket surrounding and in contact with the central core, the protective jacket formed from a second thermoplastic material;
an armor layer surrounding and in contact with the protective jacket, the armor layer comprising a plurality of metal rods disposed in an annular array; and
a plurality of optical fibers disposed within the central core.

2. The fiber optic cable of claim 1, wherein the armor layer is the outermost layer.

3. The fiber optic cable of claim 1, further comprising an outer jacket surrounding and in contact with the armor layer, the outer jacket formed from a third thermoplastic material.

4. The fiber optic cable of claim 3, wherein the third thermoplastic material is a high density polyethylene.

5. The fiber optic cable of claim 1, wherein the first thermoplastic material is a high density polyethylene.

6. The fiber optic cable of claim 1, wherein the second thermoplastic material is a polyurethane.

7. The fiber optic cable of claim 1, wherein the metal rods are steel rods.

8. The fiber optic cable of claim 1, wherein the metal rods are helically stranded.

9. The fiber optic cable of claim 1, further comprising a plurality of strength rods embedded in the central core.

10. The fiber optic cable of claim 1, wherein a maximum outer diameter of the cable is less than or equal to 26.5 millimeters.

11. The fiber optic cable of claim 10, wherein the plurality of optical fibers is greater than or equal to 144 optical fibers.

12. The fiber optic cable of claim 10, wherein the plurality of optical fibers is greater than or equal to 432 optical fibers.

13. The fiber optic cable of claim 10, wherein the plurality of optical fibers are arranged as a plurality of intermittently bonded optical fiber ribbons.

14. The fiber optic cable of claim 1, further comprising a water blocking tape disposed between the plurality of optical fibers and the central core.

15. A fiber optic cable, comprising:
a central core formed from a first thermoplastic material, wherein a central interior is defined within the central core;
a protective jacket surrounding and in contact with the central core, the protective jacket formed from a second thermoplastic material;
an armor layer surrounding and in contact with the protective jacket, the armor layer comprising a plurality of metal rods disposed in an annular array;
an outer jacket surrounding and in contact with the armor layer, the outer jacket formed from a third thermoplastic material; and
a plurality of optical fibers disposed within the central core,
wherein a maximum outer diameter of the cable is less than or equal to 26.5 millimeters and the plurality of optical fibers is greater than or equal to 144 optical fibers.

16. The fiber optic cable of claim 15, wherein the plurality of optical fibers is greater than or equal to 432 optical fibers.

17. The fiber optic cable of claim 15, wherein the plurality of optical fibers are arranged as a plurality of intermittently bonded optical fiber ribbons.

18. A fiber optic cable, comprising:
a central core formed from a high density polyethylene, wherein a central interior is defined within the central core;
a protective jacket surrounding and in contact with the central core, the protective jacket formed from a polyurethane;
an armor layer surrounding and in contact with the protective jacket, the armor layer comprising a plurality of steel rods disposed in an annular array;
an outer jacket surrounding and in contact with the armor layer, the outer jacket formed from a high density polyethylene; and
a plurality of optical fibers disposed within the central core,
wherein a maximum outer diameter of the cable is less than or equal to 26.5 millimeters and the plurality of optical fibers is greater than or equal to 144 optical fibers.

19. The fiber optic cable of claim 18, wherein the plurality of optical fibers is greater than or equal to 432 optical fibers.

20. The fiber optic cable of claim 18, wherein the plurality of optical fibers are arranged as a plurality of intermittently bonded optical fiber ribbons.
